(19) United States
(12) Patent Application Publication
(10) Pub. No.: US 2025/0149588 A1
(43) Pub. Date: May 8, 2025

(54) NEGATIVE ELECTRODE FOR ALL SOLID-STATE BATTERY AND ALL SOLID-STATE BATTERY INCLUDING THE SAME

(71) Applicant: SAMSUNG SDI CO., LTD., Yongin-si (KR)

(72) Inventors: Myoungki MIN, Yongin-si (KR); Hoseon YOU, Yongin-si (KR)

(21) Appl. No.: 18/650,208

(22) Filed: Apr. 30, 2024

(30) Foreign Application Priority Data
Nov. 2, 2023 (KR) 10-2023-0150317

(51) Int. Cl. H01M 4/62; H01M 4/02; H01M 4/13

(52) U.S. Cl. CPC H01M 4/623; H01M 4/13; H01M 4/625; H01M 4/626; H01M 2004/027

(57) ABSTRACT

A negative electrode for an all-solid-state battery and an all-solid-state battery including the negative electrode for an all-solid-state battery, the negative electrode includes a current collector; a negative electrode coating layer on the current collector; and a binder layer continuously along or discontinuously along an edge of the current collector.

### CROSS-REFERENCE TO RELATED APPLICATION

This application claims priority to and the benefit of Korean Patent Application No. 10-2023-0150317 filed in the Korean Intellectual Property Office on Nov. 2, 2023, the entire contents of which are incorporated herein by reference.

### BACKGROUND

### 1. Field

Embodiments relate to a negative electrode for an all-solid-state battery and an all-solid-state battery including the same.

### 2. Description of the Related Art

Recently, there has been a rapid progress in electric devices using batteries, such as mobile phones, laptop computers, and electric vehicles.

Such batteries may include lithium ion rechargeable batteries. Currently commercialized lithium ion rechargeable batteries may use graphite, silicon, or a mixture thereof as a negative electrode active material. Even though higher energy density is increasingly required, the rechargeable lithium batteries using graphite, silicon, or a mixture thereof as a negative electrode active material may not meet this requirement. In addition, safety issues on the rechargeable lithium batteries are being reported.

Accordingly, development of an all-solid-state battery using lithium metal as a negative electrode is being made. The all-solid-state battery refers to a battery made up of all solid materials, e.g., a battery using a solid electrolyte. A lithium metal has a high average voltage due to a large potential difference with a positive electrode and in addition, has theoretical capacity of about 3,860 mAh/g and may realize high energy density. In addition, the solid electrolyte may have a low risk of fire and may also realize safety.

### SUMMARY

The embodiments may be realized by providing a negative electrode for an all-solid-state battery, the negative electrode including a current collector; a negative electrode coating layer on the current collector; and a binder layer continuously or discontinuously along an edge of the current collector.

The binder layer may be on the same surface of the current collector as the negative electrode coating layer is on the current collector.

The binder layer may include a first surface in contact with the current collector and a second surface opposite to the first surface, and the negative electrode coating layer may cover the second surface of the binder layer.

A height of the binder layer may be the same as a height of the negative electrode coating layer.

The binder layer may be discontinuously on the edge of the current collector.

A height of the binder layer may be smaller than a height of the negative electrode coating layer.

A height of the binder layer may be about 5% to about 70% of a height of the negative electrode coating layer.

A ratio of a height of the negative electrode coating layer to a height of the binder layer may be about 1:0.05 to about 1:0.7.

A width of the binder layer may be greater than or equal to about 0.5 mm and less than or equal to about 10 mm.

The binder layer may include a non-aqueous binder, an aqueous binder, a dry binder, or a combination thereof.

The negative electrode coating layer may include a metal, a carbon material, and a negative electrode binder, and an amount of the negative electrode binder may be about 1 wt % to about 9 wt %, based on a total weight of the negative electrode coating layer.

The amount of the negative electrode binder may be about 1 wt % to about 6.6 wt %, based on the total weight of the negative electrode coating layer.

The carbon material may include amorphous carbon, crystalline carbon, or a mixture thereof.

The metal may include Ag, Au, Sn, Zn, Al, Mg, Ge, Cu, In, Ni, Bi, Pt, Pd, Si, or a combination thereof.

The negative electrode binder may include a non-aqueous binder.

The embodiments may be realized by providing an all-solid-state battery including the negative electrode according to an embodiment; a positive electrode; and a solid electrolyte layer between the negative electrode and the positive electrode.

The solid electrolyte layer may include a sulfide solid electrolyte.

The all-solid-state battery may further include a lithium-containing layer formed during initial charging between the current collector and the negative electrode coating layer.

### BRIEF DESCRIPTION OF THE DRAWINGS

Features will be apparent to those of skill in the art by describing in detail exemplary embodiments with reference to the attached drawings in which:

FIG. 1 is a schematic view showing a negative electrode for an all-solid-state battery according to some embodiments.

FIG. 2A is a plan view of a negative electrode for an all-solid-state battery according to some embodiments.

FIG. 2B is a plan view showing a negative electrode for an all-solid-state battery according to some embodiments.

FIG. 2C is a plan view showing a negative electrode for an all-solid-state battery according to some embodiments.

FIG. 3 is a schematic view showing a negative electrode for an all-solid-state battery according to some embodiments.

FIG. 4 is a cross-sectional view schematically showing an all-solid-state battery according to some embodiments.

FIG. 5 is a cross-sectional view schematically showing an all-solid-state battery according to some embodiments.

FIG. 6 is an image of the negative electrode after performing the warm isostatic pressure process of Example 1.

FIG. 7 is an image of the negative electrode after performing the warm isostatic pressure process of Comparative Example 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

The terminology used herein is used to describe embodiments only, and is not intended to limit the present disclosure. The singular expression includes the plural expression unless the context clearly dictates otherwise.

As used herein, “combination thereof” refers to a mixture, a laminate, a composite, a copolymer, an alloy, a blend, a reaction product, and the like of constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

Throughout the specification of the present disclosure, when it is said that a constituent component “includes” a certain component, this means that it does not exclude other components but may further include other components, unless specifically stated to the contrary.

In addition, the terms “about,” “substantially,” etc. used throughout the specification herein are used in the sense of being at or close to that value when manufacturing and material tolerances inherent in the stated meaning are presented and are used to prevent unscrupulous infringers from taking unfair advantage of disclosures in which precise or absolute figures are mentioned so as to aid understanding of the present disclosure.

Throughout this specification, the description of “A and/or B” and “A or B” means “A or B or both.”

Herein, “particle size” or “particle diameter” may be an average particle size. Additionally, the average particle size may be defined as the average particle size (D50) based on 50% of the cumulative volume in the cumulative size-distribution curve. The particle diameter may be measured by methods well known to those skilled in the art, for example, by measuring with a particle size analyzer, a transmission electron microscope or scanning electron microscope, a scanning electron microscope or field emission scanning electron microscopy (FE-SEM). Alternatively, a dynamic light-scattering measurement device is used to perform a data analysis, and the number of particles is counted for each particle size range. From this, the average particle diameter (D50) value may be easily obtained through a calculation. A laser diffraction method may also be used. When measuring by laser diffraction, more specifically, the particles to be measured are dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle size (D50) based on 50% of the particle size distribution in the measuring device may be calculated.

“Thickness” or “height” may be measured through a picture taken with an optical microscope such as a scanning electron microscope.

Some embodiments relate to a negative electrode for an all-solid-state battery including a negative electrode coating layer.

In some embodiments, the negative electrode coating layer refers to a layer that helps lithium ions released from the positive electrode active material move toward the negative electrode during charging and discharging of an all-solid-state battery to facilitate deposit on the surface of the current collector. In an implementation, a lithium deposition layer may be formed between the current collector and the negative electrode coating layer due to precipitation of lithium ions, and the lithium deposition layer may serve as a negative electrode active material. This negative electrode may be generally referred to as a deposition-type negative electrode. The metal and carbon materials included in the negative electrode coating layer may not act as a negative electrode active material that directly participates in charge and discharge reactions. This deposition-type negative electrode may not include a negative electrode active material during battery assembly, but may refer to a negative electrode in which the lithium deposition layer serves as a negative electrode active material. To explain this in more detail, if charging an all-solid-state battery, lithium ions may be released from the positive electrode active material, pass through the solid electrolyte, move toward the negative electrode, and may be electrodeposited on the negative electrode current collector, resulting in formation of a lithium deposition layer between the negative electrode current collector and the negative electrode coating layer.

The negative electrode for an all-solid-state battery may include a current collector, a negative electrode coating layer on the current collector, and a binder layer.

In an implementation, the binder layer may be continuously or discontinuously present along the edge or edges of the current collector. In the negative electrode, the negative electrode coating layer and the binder layer may be present separately on a current collector. The binder layer and the negative electrode coating layer may exist separately.

In an implementation, the edge of the current collector may not mean the side of the current collector, but rather the edge or periphery of a (e.g., major) surface of the current collector. In an implementation, the binder layer may be on the same surface of the current collector that the negative electrode coating layer is on the current collector. Separately from the negative electrode coating layer, the binder layer at the edge of the current collector may hold the negative electrode coating layer well. In an implementation, the binder layer may hold both the negative electrode coating layer and the current collector, and may be pressed during the negative electrode manufacturing process, even if the negative electrode coating layer were to be separated from the current collector, and the binder layer may act as a bridge to hold it from the side. Even if the binder amount included in the negative electrode coating layer were to be reduced, the negative electrode coating layer may be prevented from being separated from the current collector.

In this way, if the binder amount included in the negative electrode coating layer were to be reduced, the lithium deposition layer deposited on the current collector during charging of the all-solid-state battery may be better formed. This may be because the binder acts as a resistance, the binder amount may be reduced, and the resistance may decrease, making it easier for lithium ions to pass through the negative electrode coating layer.

A decrease in the binder amount included in the negative electrode coating layer could cause the negative electrode coating layer to fall off from the current collector during the all-solid-state battery manufacturing process, e.g., during the pressing process.

In contrast, in the negative electrode according to some embodiments, as described above, a binder layer may be at the edge of the current collector, thereby acting as a bridge between the substrate and the negative electrode coating layer and thus a binding force between the substrate and the negative electrode coating layer may be improved and the negative electrode coating layer may be prevented from falling off from the current collector.

If the binder layer were to entirely cover the current collector, the binder layer and the current collector could be combined, and lithium electrodeposition could not occur between the current collector and the negative electrode coating layer, but rather could occur between the binder layer and the negative electrode coating layer. As this occurs, the negative electrode coating layer could be torn, and the resistance within the negative electrode could increase due to an increase in the binder amount, making electrodeposition and desorption of lithium difficult.

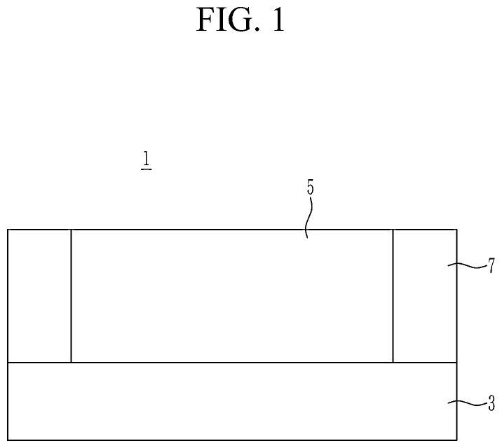

In an implementation, a height (e.g., thickness) of the binder layer may be the same as a height of the negative electrode coating layer. In an implementation, the binder layer may include a first surface in contact with the current collector and a second surface opposite to the first surface, and the solid electrolyte layer may cover the second surface. Referring to FIG. 1, which is a cross-sectional view schematically showing the negative electrode 1 according to some embodiments, the negative electrode 1 may include a current collector 3, a negative electrode coating layer 5 on the current collector 3, and a binder layer 7.

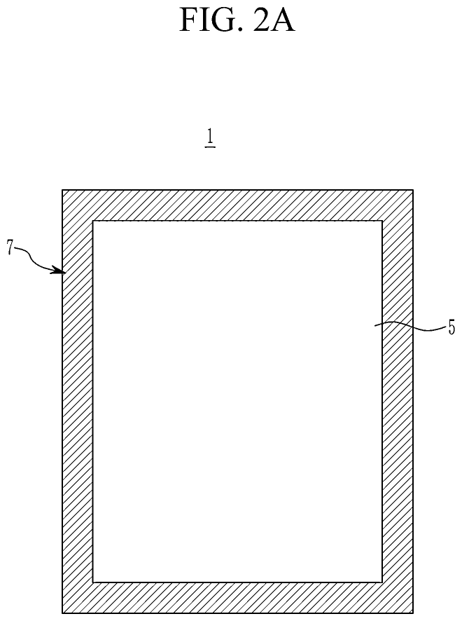

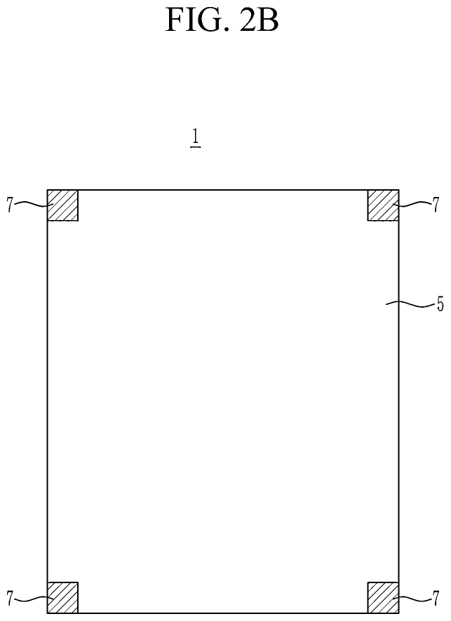

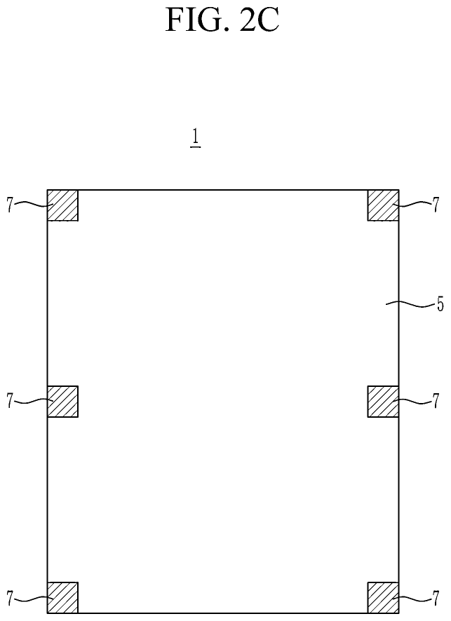

In an implementation, the binder layer 7 may be continuously present at or on the edge or edges of the current collector, as shown in FIG. 2A showing a plan view of the negative electrode 1, and the binder layer 7 may surround the negative electrode coating layer 5. In an implementation, as shown in FIGS. 2B and 2C, the binder layer 7 may be discontinuously present on the edges of the current collector. In an implementation, the binder layer 7 may be present at the corners, e.g., only the corners of the negative electrode coating layer 5, or may be present not only at the corners but also at the center (e.g., a certain distance) between the two corners.

In an implementation, a height of the binder layer may be smaller than a height of the negative electrode coating layer. In an implementation, the binder layer may include a first surface in contact with the current collector and a second surface opposite to the first surface, and the negative electrode coating layer may cover the second surface.

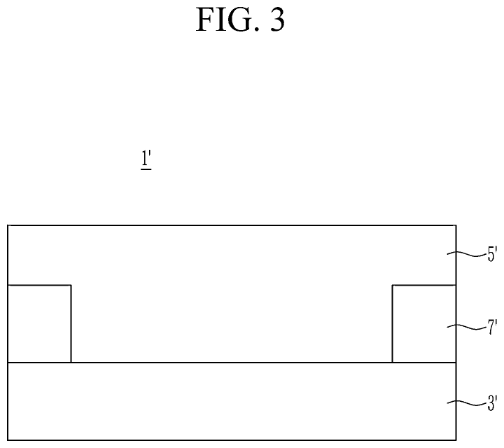

Referring to FIG. 3, which is a schematic cross-sectional view of a negative electrode 1′ according to some embodiments, the negative electrode 1′ may include a current collector 3′, a negative electrode coating layer 5′ on the current collector 3′, and a binder layer 7′.

In an implementation, a thickness or height of the binder layer may be about 5% to about 70% of a height of the negative electrode coating layer, e.g., about 10% to about 70% of the height of the negative electrode coating layer. The height of the negative electrode coating layer means a height of the center of the negative electrode coating layer (e.g., as measured from the current collector). Maintaining the height of the binder layer within the above ranges may help ensure that the contact area with the negative electrode coating layer may be increased, thereby further increasing the binding force. The negative electrode reaction may occur in this area, and the N/P ratio (negative electrode/positive electrode capacity ratio) may be more appropriately adjusted.

In an implementation, a ratio of the height of the negative electrode coating layer to the height of the binder layer may be about 1:0.05 to about 1:0.7, or about 1:0.1 to about 1:0.5.

Maintaining the height of the binder layer and the ratio of the height of the negative electrode coating layer to the height of the binder layer within the above ranges may help ensure that the binding force between the binder layer and the negative electrode coating layer may be further increased, and a contact area with the active mass layer may be increased, thereby increasing a binding force, and an N/P ratio (capacity ratio of negative electrode/positive electrode) may be adjusted more appropriately. In this disclosure, the active mass layer refers to a layer including the active material and the binder, optionally, the conductive material, and, e.g., it refers to an active material layer.

In an implementation, the binder layer may have the same height as the negative electrode coating layer or a height less than the negative electrode coating layer. In an implementation, a width of the binder layer may be greater than or equal to about 0.5 mm and less than or equal to about 10 mm, or greater than or equal to about 1 mm and less than or equal to about 5 mm. Maintaining the width of the binder layer within the above ranges may help ensure that a more stable binding force is provided between the substrate and the negative electrode coating layer, and a utilization rate of the negative electrode may be further increased. In an implementation, the binder layer may be continuously present along the edge of the current collector, and the edge portion of the current collector may be prevented from reacting, effectively suppressing the occurrence of short circuits during battery operation.

In an implementation, the binder in the binder layer may be a suitable binder for rechargeable lithium batteries. The binder may include, e.g., a non-aqueous binder, an aqueous binder, a dry binder, or a combination thereof.

The non-aqueous binder may include, e.g., polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include, e.g., a styrene-butadiene rubber, a (meth)acrylated styrene-butadiene rubber, a (meth)acrylonitrile-butadiene rubber, a (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridin, chlorosulfonated polyethylene, latex, a polyester resin, a (meth)acrylic resin, a phenol resin, an epoxy resin, polyvinyl alcohol, or a combination thereof.

A cellulose compound may be used as a binder, and the cellulose compound and the aqueous binder may also be used together. The cellulose compound may include one or more of, e.g., carboxymethyl cellulose, hydroxypropylmethyl cellulose, methyl cellulose, or an alkali metal salt thereof. The alkali metal may include, e.g., Na, K, or Li.

The dry binder may be a polymer material capable of being fibrous, and may include, e.g., polytetrafluoroethylene, polyvinylidene fluoride, a polyvinylidene fluoride-hexafluoropropylene copolymer, polyethylene oxide, or a combination thereof.

The negative electrode coating layer may include, e.g., a metal, a carbon material, and a negative electrode binder. An amount of the negative electrode binder may be, e.g., about 1 wt % to about 9 wt %, about 1 wt % to about 6.6 wt %, or about 1 wt % to about 4 wt %, based on a total weight of the negative electrode coating layer. In an implementation, the binder amount of the negative electrode coating layer according to some embodiments may be smaller than the binder amount of about 11 wt % included in some other negative electrode coating layers.

The negative electrode according to some embodiments may include a binder layer at the edges of the current collector separately from the negative electrode coating layer, thereby reducing the binder amount of the negative electrode coating layer.

If a separate binder layer were not included and the binder amount of the negative electrode coating layer were to be less than about 11 wt %, the negative electrode coating layer could fall off from the current collector during battery manufacturing, which may not be appropriate.

In the negative electrode coating layer, e.g., a metal may be supported on a carbon material, or a mixture of metal and carbon material may exist.

The metal supported on a carbon material may be obtained by performing a supporting process of mixing a metal compound and a reducing agent. The metal compound may include a metal nitride, a metal sulfate, a metal perchlorate, or a combination thereof. In an implementation, the metal may be Ag, and the metal compound may be AgNO₃, Ag₂SO₄, AgClO₄, or a combination thereof. The reducing agent may be NaBH₄, ascorbic acid, trisodium citrate, ethylene glycol, or a combination thereof.

The carbon material may include, e.g., crystalline carbon, amorphous carbon, or a combination thereof, or may be amorphous carbon. The crystalline carbon may include, e.g., irregular-shaped, plate-shaped, flake-shaped, spherical or fibrous natural graphite, artificial graphite, mesophase carbon microbeads, or a combination thereof. The amorphous carbon may include, e.g., carbon black, acetylene black, denka black, ketjen black, furnace black, activated carbon, graphene, or a combination thereof. An example of the carbon black may include Super P (Timcal Corporation). In an implementation, the amorphous carbon may include a suitable material classified as amorphous carbon in the relevant field.

In an implementation, the carbon material may be a single particle or an agglomerated product having the form of secondary particles in which primary particles are agglomerated. In an implementation, the carbon material may be a single particle, and the size of the carbon material may be nano-sized with an average particle diameter of less than or equal to about 100 nm, e.g., about 10 nm to about 100 nm.

In an implementation, the carbon material may be a granular material, the primary particle may have a particle diameter of about 20 nm to about 100 nm, and the secondary particle may have a particle diameter of about 1 μm to about 20 μm.

In an implementation, the particle diameter of the primary particle may be, e.g., greater than or equal to about 20 nm, greater than or equal to about 30 nm, greater than or equal to about 40 nm, greater than or equal to about 50 nm, greater than or equal to about 60 nm, greater than or equal to about 70 nm, greater than or equal to about 80 nm, or greater than or equal to about 90 nm, and less than or equal to about 100 nm, less than or equal to about 90 nm, less than or equal to about 80 nm, less than or equal to about 70 nm, less than or equal to about 60 nm, less than or equal to about 50 nm, less than or equal to about 40 nm, or less than or equal to about 30 nm.

In an implementation, the particle diameter of the secondary particles may be, e.g., greater than or equal to about 1 μm, greater than or equal to about 3 μm, greater than or equal to about 5 μm, greater than or equal to about 7 μm, greater than or equal to about 10 μm, or greater than or equal to about 15 μm and less than or equal to about 20 m, less than or equal to about 15 μm, less than or equal to about 10 μm, less than or equal to about 7 μm, less than or equal to about 5 μm, or less than or equal to about 3 m.

The shape of the primary particles may be spherical, elliptical, plate-shaped, or combinations thereof. In an implementation, the shape of the primary particles may be spherical, elliptical, or a combination thereof.

The metal may act as a catalyst, e.g., Ag, Au, Sn, Zn, Al, Mg, Ge, Cu, In, Ni, Bi, Pt, Pd, Si or a combination thereof, or an alloy thereof. In an implementation, the metal may be Ag. In an implementation, the negative electrode coating layer may include the metal, and the electrical conductivity of the negative electrode may be further improved.

The metal may be a nanoparticle, and an average size of the metal nanoparticle may be, e.g., about 5 nm to about 80 nm, or nanometer-sized particles may be appropriately used. By using the metal nanoparticles having such a nano-size, battery characteristics (e.g., cycle-life characteristics) of an all-solid-state battery may be improved. If the metal particle size were to increase to be in micrometers, the uniformity of the metal particles in the negative electrode coating layer could decrease, the current density in a specific area could increase, and cycle-life characteristics could deteriorate.

In the negative electrode coating layer, a mixing ratio of the metal and the carbon material may be, e.g., a weight ratio of about 1:10 to about 1:0.5. In this case, deposition of lithium metal may be promoted more effectively and the characteristics of the all-solid-state rechargeable battery may be improved.

The negative electrode coating layer may further include additives, e.g., fillers and dispersants. In an implementation, suitable materials used in all-solid-state batteries may be used as fillers, dispersants, or the like may be included in the negative electrode coating layer.

The thickness of the negative electrode coating layer may be about 1 μm to about 20 km. In an implementation, the thickness of the negative electrode coating layer may be greater than or equal to about 1 μm, greater than or equal to about 3 μm, or greater than or equal to about 5 μm, and less than or equal to about 20 μm, less than or equal to about 18 μm, less than or equal to about 16 μm, less than or equal to about 14 m, less than or equal to about 12 μm, or less than or equal to about 10 km.

The negative electrode binder may be, e.g., a non-aqueous binder.

The non-aqueous binder may include, e.g., polyvinylchloride, carboxylated polyvinylchloride, polyvinylfluoride, an ethylene oxide-containing polymer, an ethylene propylene copolymer, polystyrene, polyvinylpyrrolidone, polyurethane, polytetrafluoroethylene, polyvinylidene fluoride, polyethylene, polypropylene, polyamideimide, polyimide, polyacrylate, or a combination thereof.

The current collector may include, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil or sheet. A thickness of the negative electrode current collector may be about 1 μm to about 20 μm, about 5 μm to about 15 μm, or about 7 μm to about 10 km.

The current collector may include a metal substrate and may further include a thin film on the substrate. The thin film may include an element that may form an alloy with lithium, and may be, e.g., gold, silver, zinc, tin, indium, silicon, aluminum, bismuth, or a combination thereof. In an implementation, a suitable element that may form an alloy with lithium may be used. In an implementation, the current collector may further include a thin film, the lithium-containing layer may be formed by depositing during charging, and a more flattened lithium-containing layer may be formed, thereby further improving the cycle-life of the all-solid-state battery.

A thickness of the thin film may be about 1 nm to about 800 nm, about 10 nm to about 700 nm, about 50 nm to about 600 nm, or about 100 nm to about 500 nm. Maintaining the thin film thickness within the above ranges may help ensure that cycle-life characteristics may be further improved.

The negative electrode according to some embodiments may be manufactured by the following process, and as long as the negative electrode having the binder layer and negative electrode coating layer configuration according to some embodiments may be manufactured, it may be manufactured by a suitable method.

The binder layer composition may be coated continuously or discontinuously along the edge of the current collector and dried to form a binder layer.

The binder layer composition may include a binder and a solvent. The binder may be as described above. The solvent may include, e.g., water or an organic solvent. The organic solvent may include, e.g., N-methyl pyrrolidone, octyl acetate, diethyl carbonate, pentyl propionate, or a combination thereof. A suitable solvent may be used as long as it may dissolve the binder. An amount of the binder may be about 4 wt % to about 50 wt %, or about 4 wt % to about 25 wt %, based on a total weight of the binder layer composition. A viscosity of the binder layer composition may be about 500 cps to about 3,000 cps, or about 750 cps to about 2,000 cps at about 20° C. to about 25° C. In an implementation, the amount of the binder may be appropriately adjusted to obtain the viscosity of the binder layer composition.

The process of coating the binder layer composition may be performed by pattern coating. The pattern coating may be performed, e.g., by gravure coating the binder layer composition on a current collector using a gravure coater, or may be performed using a mask film. The method of using a mask film may also be carried out by attaching a patterned mask film onto a current collector, coating it with a binder layer composition, and then removing the mask film. In an implementation, a mask film may be used, and suitable coaters such as a slot die and a 3-roll reverse comma coater may be used.

In this process, a coating thickness of the binder layer composition may be adjusted to form a binder layer with the same thickness as the negative electrode coating layer, or the binder layer may be formed lower or thinner than the negative electrode coating layer.

The drying process may be performed at about 60° C. to about 120° C.

Subsequently, the negative electrode coating layer composition may be coated on the current collector and dried to form a negative electrode coating layer. The negative electrode coating layer composition may include a metal, a carbon material, a binder, and a solvent. The carbon material may be the amorphous carbon or crystalline carbon described above. The metal may be the metal described above, and the binder may be the binder described above.

The amounts of the metal, the carbon material, and the binder may be adjusted to have the aforementioned amounts included in the negative electrode coating layer.

The solvent may include, e.g., N-methylpyrrolidone (NMP), benzene, hexane, tetrahydrofuran (THF), ethanol, isopropyl alcohol (IPA), dimethyl sulfoxide, dimethylformamide, acrylonitrile, or a combination thereof.

The method of coating the negative electrode coating layer composition may be performed through a suitable coating process, e.g., spray coating or gravure coating.

In an implementation, the binder layer may be lower or thinner than the negative electrode coating layer, the negative electrode coating layer composition may be coated to cover the upper portion of the binder layer, and the coating process may be performed so that the negative electrode surface may be substantially completely covered with the negative electrode coating layer.

The drying process may be performed at about 60° C. to about 120° C.

Some embodiments provide an all-solid-state battery including the negative electrode, a positive electrode, and a solid electrolyte layer between the negative electrode and the positive electrode.

The negative electrode according to some embodiments may further include a lithium-containing layer (formed during initial charging after manufacturing the battery) between the current collector and the negative electrode coating layer. A thickness of the lithium-containing layer may be about 1 μm to about 1,000 μm, about 1 μm to about 500 m, about 1 μm to about 200 μm, about 1 μm to about 150 μm, about 1 μm to about 100 m, or about 1 μm to about 50 μm. Maintaining the thickness of the lithium-containing layer within the above ranges may help ensure that it may properly function as a lithium storage layer and may help further improve its cycle-life.

The lithium-containing layer may be formed after manufacturing a battery, during charging, lithium ions may be released from the positive electrode active material, and may pass through the solid electrolyte and move toward the negative electrode, and as a result, lithium may be precipitated and deposited on the negative electrode current collector.

The charging process may be a formation process performed once to three times at 0.05 C to 1 C at about 25° C. to about 60° C. In an implementation, lithium may be precipitated and deposited to form a lithium-containing layer, and the lithium included in the lithium-containing layer may be ionized and may move toward the positive electrode during discharge, so that this lithium may be used as a negative electrode active material.

In an implementation, the lithium-containing layer may be present between the current collector and the negative electrode coating layer, and the negative electrode coating layer may serve as a protective layer for the lithium-containing layer, thereby suppressing the deposition growth of lithium dendrites. As a result, short circuiting and capacity reduction of the all-solid-state battery may be suppressed, and as a result, the cycle-life of the all-solid-state battery may be improved.

The solid electrolyte layer may include a solid electrolyte. This solid electrolyte may be an inorganic solid electrolyte, e.g., a sulfide solid electrolyte, an oxide solid electrolyte, or a halide solid electrolyte, or a solid polymer electrolyte.

In an implementation, the sulfide solid electrolyte may be, e.g., Li₂S—P₂S₅, Li₂S—P₂S₅—LiX (in which X is a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are integers of 0 or more and 12 or less and Z is Ge, Zn, or Ga), Li₂S—GeS₂, Li₂S—SiS₂—Li₃PO₄, Li₂S—SiS₂-LiₚMO_{q} (in which p and q are each 0 or more and 12 or less and M is P, Si, Ge, B, Al, Ga, or In), or LiₐM_{b}P_{c}S_{d}Aₑ (in which a, b, c, d, and e are each 0 or more and 12 or less, M is Ge, Sₙ, Si, or a combination thereof, and A is F, Cl, Br, or I). The sulfide solid electrolyte may be, e.g., Li₇₋ₓPS₆₋ₓFₓ (0≤x≤2), Li₇₋ₓPS₆₋ₓClₓ (0≤x≤2), Li₇₋ₓPS₆₋ₓBrₓ(0≤x≤2), or Li₇₋ₓPS₆₋ₓIₓ (0≤x≤2). It may be Li₃PS₄, Li₇P₃S₁₁, Li₇PS₆, Li₆PS₅Cl, Li₆PS₅Cl, Li₆PS₅I, Li₆PS₅Br, Li_{5.8}PS_{4.8}Cl_{1.2}, Li_{6.2}PS_{5.2}Br_{0.8}, or the like.

In an implementation, the sulfide solid electrolyte may be an argyrodite-type sulfide solid electrolyte. The argyrodite-type sulfide solid electrolyte may be, e.g., LiₐM_{b}P_{c}S_{d}Aₑ (in which a, b, c, d and e are all 0 or more and 12 or less, M is Ge, Sₙ, Si, or a combination thereof, and A is F, Cl, Br, or I), Li₃PS₄, Li₇P₃S₁₁, Li₇PS₆, Li₆PS₅Cl, Li₆PS₅Br, Li₆PS₅I, Li_{5.8}PS_{4.8}Cl_{1.2}, Li_{6.2}PS_{5.2}Br_{0.8}, or the like.

The sulfide solid electrolyte may be amorphous, crystalline, or a mixed state thereof. The sulfide solid electrolyte may be obtained by, e.g., mixing Li₂S and P₂S₅ in a mole ratio of about 50:50 to about 90:10 or about 50:50 to about 80:20. Within the above mixing ratio ranges, a sulfide solid electrolyte having excellent ion conductivity may be prepared. The ion conductivity may be further improved by adding SiS₂, GeS₂, B₂S₃, or the like as other components thereto. Mechanical milling or a solution method may be applied as a mixing method. The mechanical milling may make starting materials into particulates by putting the starting materials, ball mills, and the like in a reactor and vigorously stirring them. The solution method may be performed by mixing the starting materials in a solvent to obtain a solid electrolyte as a precipitate. In an implementation, additional firing may be performed after mixing. In an implementation, the additional firing may be performed, and the crystals of the solid electrolyte may become more solid.

In an implementation, a commercially available solid electrolyte may be used as the sulfide solid electrolyte.

The oxide solid electrolyte may be, e.g., Li₁₊ₓTi₂₋ₓAl(PO₄)₃(LTAP) (0≤x≤4), Li_{1+x+y}AlₓTi₂₋ₓSi_{y}P_{3-y}O₂ (0≤x≤2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), Pb(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0<x<1, 0<y<1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (M=Te, Nb, or Zr, and x is an integer of 1 to 10), or a mixture thereof.

The solid polymer electrolyte may include, e.g., polyethylene oxide, poly(diallyldimethylammonium) trifluoromethanesulfonylimide (poly(diallyldimethylammonium)TFSI), Cu₃N, Li₃N, LiPON, Li₃PO₄·Li₂S·SiS₂, Li₂S·GeS₂·Ga₂S₃, Li₂O·11Al₂O₃, Na₂O·11Al₂O₃, (Na,Li)₁₊ₓTi₂₋ₓAlₓ(PO₄)₃(0.1≤x≤0.9), Li₁₊ₓHf₂₋ₓAlₓ(PO₄)₃(0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-silicates, Li_{0.3}La_{0.5}TiO₃, Na₅MSi₄O₁₂ (in which M is a rare earth element of Nd, Gd, Dy, or the like), Li₅ZrP₃O₁₂, Li₅TiP₃O₁₂, Li₃Fe₂P₃O₁₂, Li₄NbP₃O₁₂, Li₁₊ₓ(M,Al,Ga)ₓ(Ge_{1-y}Ti_{y})₂₋ₓ(PO₄)₃(x≤0.8, 0≤y≤1.0, M is Nd, Sm, Eu, Gd, Tb, Dy, Ho, Er, Tm, or Yb), Li_{1+x+y}QₓTi₂₋ₓSi_{y}P_{3-y}O₁₂ (0≤x≤0.4, 0≤y≤0.6, Q is Al or Ga), Li₆BaLa₂Ta₂O₁₂, Li₇La₃Zr₂O₁₂, Li₅La₃Nb₂O₁₂, Li₅La₃M₂O₁₂ (M is Nb, Ta), or Li₇₊ₓAₓLa₃₋ₓZr₂O₁₂ (0<x<3, A is Zn).

The halide solid electrolyte may include a Li element, an M element (in which M is a metal other than Li), and an X element (in which X is a halogen). Examples of X may include F, Cl, Br, and I. In an implementation, in the halide solid electrolyte, at least one of Br and Cl may be suitable as the above X. Examples of M may include metal elements such as Sc, Y, B, Al, Ga, or In.

In an implementation, a composition of the halide solid electrolyte may be represented by Li₆₋₃ₐMₐBr_{b}Cl_{c} (in which M is a metal other than Li, 0<a<2, 0≤b≤6, 0≤c≤6, b+c=6). In an implementation, a may be 0.75 or more, 1 or more, and a may be 1.5 or less. The b may be 1 or more, and may be 2 or more. In an implementation, c may be 3 or more, and may be 4 or more. Examples of the halide solid electrolyte may include Li₃YBr₆, Li₃YCl₆, or Li₃YBr₂Cl₄.

The solid electrolyte may in the form of particles, and an average particle diameter (D50) may be less than or equal to about 5.0 μm, e.g., about 0.1 μm to about 5.0 μm, about 0.5 μm to about 5.0 μm, about 0.5 μm to about 4.0 μm, about 0.5 μm to about 3.0 μm, about 0.5 μm to about 2.0 μm, or about 0.5 μm to about 1.0 μm.

The solid electrolyte layer may further include a binder. In an implementation, the binder may include styrene butadiene rubber, polytetrafluoroethylene, polyvinylidene fluoride, polyethylene, acrylate polymer, a combination thereof, or other suitable binder. The acrylate polymer may include butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may include isobutyryl isobutyrate, xylene, toluene, benzene, hexane, or a combination thereof.

The positive electrode may include a positive current collector and a positive electrode active material layer on one surface of the positive current collector.

The positive electrode active material layer may include a positive electrode active material. The positive electrode active material may be a positive electrode active material capable of reversibly intercalating and deintercalating lithium ions. In an implementation, the positive electrode active material may include a composite oxide of lithium and a metal, e.g., cobalt, manganese, nickel, or a combination thereof. Examples of the positive electrode active material may include, LiₐA_{1-b}B¹_{b}D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c} (0.90≤a≤1.8, 0≤b≤0.5, 0≤c≤0.5); LiₐN_{1-b-c}Co_{b}B¹_{c}D¹_{α} (0.90≤a≤1.8, 0≤b≤0.5, 0≤c≤0.5, 0<α≤2); LiₐN_{1-b-c}Co_{b}B¹_{c}O_{2-α}F¹_{α} (0.90≤a≤1.8, 0≤b≤0.5, 0≤c≤0.5, 0<α<2); LiₐNi_{1-b-c}Co_{b}B¹_{c}O_{2-α}F¹₂ (0.90≤a≤1.8, 0≤b≤0.5, 0≤c≤0.5, 0<α<2); LiₐNi_{1-b-c}Mn_{b}B¹_{c}D¹_{α} (0.90≤a≤1.8, 0≤b≤0.5, 0≤c≤0.5, 0<α≤2); LiₐNi_{1-b-c}Mn_{b}B¹_{c}O_{2-α}F¹_{α} (0.90≤a≤1.8, 0≤b≤0.5, 0≤c≤0.5, 0<α<2); LiₐNi_{1-b-c}Mn_{b}B¹_{c}O_{2-α}F¹₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QO₂; QS₂; LiQS₂; V₂O₅; LiV₂O₅; LiI¹O₂; LiNiVO₄; Li_{(3-f)}J₂(PO₄)₃(0≤f≤2); Li_{(3-f)}Fe₂(PO₄)₃(0≤f≤2); or LiFePO₄.

In the above chemical formulas, A may be Ni, Co, Mn, or a combination thereof, B¹ may be Al, Ni, Co, Mn, Cr, Fe, Mg, Sr, V, a rare earth element, or a combination thereof, D¹ may be O, F, S, P, or a combination thereof, E may be Co, Mn, or a combination thereof, F¹ may be F, S, P, or a combination thereof, G may be Al, Cr, Mn, Fe, Mg, La, Ce, Sr, V, or a combination thereof, Q may be Ti, Mo, Mn, or a combination thereof, I¹ may be Cr, V, Fe, Sc, Y, or combination thereof, J may be V, Cr, Mn, Co, Ni, Cu, or a combination thereof, and L¹ may be Mn, Al, or a combination thereof.

In an implementation, the positive electrode active material may be a ternary lithium transition metal such as LiNiₓCo_{y}Al_{z}O₂(NCA), LiNiₓCo_{y}Mn_{z}O₂(NCM) (in which 0<x<1, 0<y<1, 0<z<1, x+y+z=1).

In an implementation, the compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, e.g., the method may include a suitable coating method such as spray coating, dipping, or the like.

As the coating layer, a suitable coating layer for the positive electrode active material of an all-solid-state battery may be applied, e.g., Li₂O—ZrO₂ (LZO).

In an implementation, the positive electrode active material may be a ternary system including nickel, cobalt and manganese, or nickel, cobalt and aluminum, and the capacity density of the all-solid-state battery may be further improved and metal elution from the positive electrode active material in the charged state may be further reduced. In an implementation, the long-term reliability and cycle characteristics of the all-solid-state battery may be further improved in a charged state.

Examples of the shape of the positive electrode active material may include particle shapes such as spheres and ellipsoids. The average particle diameter of the positive electrode active material may be, e.g., within a range applicable to the positive electrode active material of all-solid-state rechargeable batteries. The amount of the positive electrode active material in the positive electrode active material layer may be, e.g., within a range applicable to the positive electrode layer of all-solid-state rechargeable batteries.

The positive electrode active material layer may further include a solid electrolyte. The solid electrolyte included in the positive electrode active material layer may be the same as or different from the solid electrolyte included in the solid electrolyte layer. The solid electrolyte may be included in an amount of about 10 wt % to about 30 wt % based on a total weight of the positive electrode active material layer.

The positive electrode current collector may include, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil or sheet.

The positive electrode active material layer may further include a binder or a conductive material.

In an implementation, the binder may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyvinylidene fluoride-hexafluoropropylene, polyethylene, polypropylene, a styrene-butadiene rubber, an acrylated styrene-butadiene rubber, an epoxy resin, nylon, or the like.

The binder may be included in an amount of about 0.1 wt % to about 5 wt %, or about 0.1 wt % to about 3 wt %, based on a total weight of the positive electrode active material layer for an all-solid-state battery. Within the above amount ranges, the binder may sufficiently exhibit adhesive ability without deteriorating battery performance.

The conductive material may impart conductivity to the electrode, and a suitable material that does not cause chemical change and conducts electrons may be used in the battery. Examples thereof may include a carbon material such as natural graphite, artificial graphite, carbon black, acetylene black, and ketjen black, a carbon fiber, a carbon nanofiber, or carbon nanotube, a metal material including copper, nickel, aluminum, silver, or the like, and in the form of a metal powder or a metal fiber, a conductive polymer such as a polyphenylene derivative, or a mixture thereof.

The conductive material may be included in an amount of about 0.1 wt % to about 5 wt %, or about 0.1 wt % to about 3 wt %, based on a total weight of the positive electrode active material layer for an all-solid-state battery. Within the above amount ranges, the conductive material may help improve electrical conductivity without deteriorating battery performance.

A thickness of the positive electrode active material layer may be about 90 μm to about 200 μm. In an implementation, the thickness of the positive electrode active material layer may be greater than or equal to about 90 μm, greater than or equal to about 100 μm, greater than or equal to about 110 μm, greater than or equal to about 120 μm, greater than or equal to about 130 μm, greater than or equal to about 140 μm, greater than or equal to about 150 μm, greater than or equal to about 160 μm, greater than or equal to about 170 μm, greater than or equal to about 180 μm, or greater than or equal to about 190 μm, greater than or equal to about 200 μm, less than or equal to about 190 μm, less than or equal to about 180 μm, less than or equal to about 170 μm, less than or equal to about 160 μm, less than or equal to about 150 μm, less than or equal to about 140 μm, less than or equal to about 130 μm, less than or equal to about 120 μm, or less than or equal to about 110 μm.

In an implementation, a cushioning material may be additionally included to buffer thickness changes that could occur if the all-solid-state battery is charged and discharged. The cushioning material may be between the negative electrode and the case, and in the case of a battery in which one or more electrode assemblies are stacked, it may be between different electrode assemblies.

The cushioning material may include a material that has an elastic recovery rate of 50% or more and has an insulating function, and may include silicone rubber, acrylic rubber, fluorine-based rubber, nylon, synthetic rubber, or a combination thereof. The cushioning material may be in the form of a polymer sheet.

The all-solid-state rechargeable battery may be a unit cell having a structure of positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

In an implementation, the shape of the all-solid-state rechargeable battery may be, e.g., coin-shaped, button-shaped, sheet-shaped, stacked-shaped, cylindrical, flat, or the like. The all-solid-state rechargeable battery may also be applied to large batteries used in electric vehicles or the like. In an implementation, the all-solid-state rechargeable battery may also be used in hybrid vehicles such as plug-in hybrid electric vehicles (PHEV). It may be used in a field requiring a large amount of power storage, and may be used, for example, in an electric bicycle or a power tool. The all-solid-state rechargeable battery may be used in various fields such as portable electronic devices.

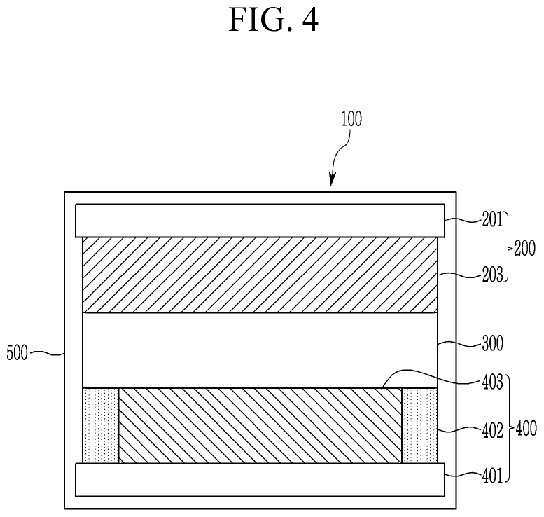

FIG. 4 is a cross-sectional view of an all-solid-state battery according to some embodiments. Referring to FIG. 4, the all-solid-state battery 100 may include an electrode assembly in which a negative electrode 400 including a negative electrode current collector 401, a negative electrode coating layer 403, and a binder layer 402, a solid electrolyte layer 300, and a positive electrode 200 including a positive electrode active material layer 203 and the positive electrode current collector 201 are stacked and a case such as a pouch housing the electrode assembly. The all-solid-state battery 100 may further include an elastic layer 500 on the outside of at least one of the positive electrode 200 and the negative electrode 400. In an implementation, as illustrated in FIG. 4, one electrode assembly may include the negative electrode 400, the solid electrolyte layer 300, and the positive electrode 200, or an all-solid-state battery may also be manufactured by stacking two or more electrode assemblies.

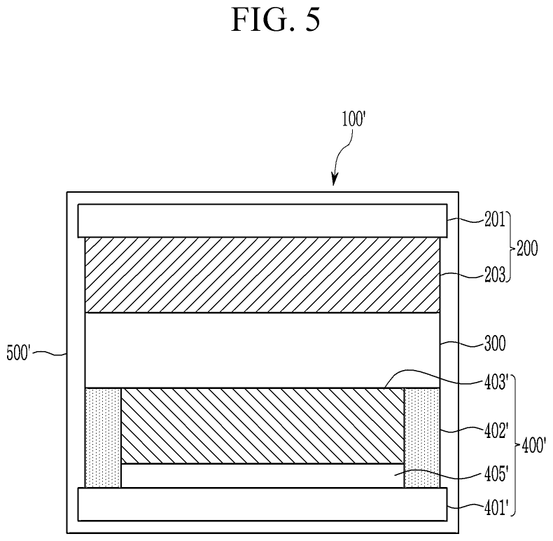

FIG. 5 schematically shows an all-solid-state battery according to some embodiments. The all-solid-state battery 100 shown in FIG. 5 may include a positive electrode 200 including a positive electrode current collector 201 and a positive electrode active material layer 203, a negative electrode 400′ including a negative electrode current collector 401′, a negative electrode coating layer 403′, and a binder layer 402′, and a solid electrolyte layer 300 between the positive electrode 200 and the negative electrode 400′, a battery case 500′ housing the same, and may also include a lithium deposition layer 405′ between the negative electrode current collector 401′ and the negative electrode coating layer 403′. This lithium deposition layer 405′ may be formed as the all-solid-state battery is charged, e.g., lithium ions may be released from the positive electrode active material and deposited on the negative electrode current collector 401′.

An all-solid-state battery according to some embodiments may be manufactured by placing a negative electrode, a positive electrode, and a solid electrolyte layer between the negative electrode and the positive electrode, preparing a stack, and pressing the stack.

The pressing process may be performed in the range of about 25° C. to about 90° C. The pressing process may be performed by pressing at a pressure of less than or equal to about 550 MPa, e.g., less than or equal to about 500 MPa, or about 1 MPa to about 500 MPa. The pressing time may vary depending on temperature and pressure, and may be, e.g., less than about 30 minutes. The pressing process may include, e.g., an isostatic press, roll press, plate press, or warm isostatic press (WIP).

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### (1) Manufacture of Negative Electrode

10 wt % of a polyvinylidene fluoride binder and 90 wt % of an N-methyl pyrrolidone solvent were mixed to prepare binder layer slurry.

After mixing carbon black (an average particle diameter: 35 nm) and Ag (an average particle diameter: 60 nm) in a weight ratio of 75:25, this mixture was mixed with an N-methylpyrrolidone (NMP) solvent in which a polyvinylidene fluoride binder was dissolved to prepare negative electrode coating layer slurry. An amount of the polyvinylidene fluoride binder was 7 parts by weight based on 100 parts by weight of the mixture of carbon black and Ag, and an amount of the binder was about 6.5 wt % based on 100 wt % of an entire negative electrode coating layer.

The binder layer slurry was coated along edges of a stainless steel foil current collector (a thickness: 10 μm) to form a binder layer with a width of 1 mm by using a gravure coater. Subsequently, the coated current collector was dried at 80° C. to form the binder layer with a thickness of 7 μm and the width of 1 mm. Herein, the binder layer was formed continuously along the edges.

Then, the negative electrode layer slurry was coated on the obtained current collector and then, vacuum-dried at 80° C. to form a 7 μm-thick negative electrode coating layer. The manufactured negative electrode had, as shown in FIGS. 1 and 2A, a structure of having the binder layer continuously formed on the edges of the current collector and the negative electrode coating layer formed on the current collector.

### (2) Preparation of Solid Electrolyte Layer

To an argyrodite-type solid electrolyte of Li₆PS₅Cl, an isobutyryl isobutyrate binder solution (a solid amount: 50 wt %) prepared by adding an acrylate-based polymer of butyl acrylate was added and then, mixed. The solid electrolyte and the binder were mixed in a weight ratio of 98.7:1.3.

The mixing process was performed by using a Thinky mixer. Subsequently, 2 mm zirconia balls were added to the obtained mixture and then, stirred again by using a Thinky mixer to prepare slurry. The slurry was cast on a release polytetrafluoroethylene film and then, dried at ambient temperature to manufacture a 100 μm-thick solid electrolyte layer.

### (3) Manufacture of Positive Electrode

A positive electrode active material (LiNi_{0.9}Mn_{0.05}Co_{0.05}O₂), an argyrodite-type solid electrolyte of Li₆PS₅Cl, a conductive material of carbon nanofiber, and a binder of polytetrafluoroethylene were mixed in a weight ratio of 85:15:3:1.5.

The prepared mixture was coated on an aluminum foil current collector and vacuum-dried at 45° C. to manufacture a positive electrode including a 160 μm-thick positive electrode active material layer on the current collector with a thickness of 10 m. The positive electrode active material layer had a thickness of 12 μm.

(4) Manufacture of all-Solid-State Full Cell

The manufactured negative electrode, the solid electrolyte, and the positive electrode were sequentially stacked and pressed under 500 MPa in a warm isostatic press process to fabricate an all-solid-state full cell.

### Example 2

A negative electrode was manufactured in the same manner as in Example 1 except that a binder layer with a thickness of 7 μm and a width of 1 mm was formed by discontinuously coating the binder layer slurry of Example 1 to be 1 mm wide only at corners of a stainless steel foil current collector (a thickness: 10 μm) by using a gravure coater and then, drying the coated current collector at 80° C. The manufactured negative electrode, as shown in FIGS. 1 and 2B, had the binder layer only on the corners of the current collector.

### Example 3

A negative electrode was manufactured in the same manner as in Example 1 except that a binder layer with a thickness of 7 μm and a width of 1 mm was formed by discontinuously coating the binder layer slurry of Example 1 to be 1 mm wide only at corners and at centers of the edges of a stainless steel foil current collector (a thickness: m) by using a gravure coater and then, drying the coated current collector at 80° C. The manufactured negative electrode, as shown in FIGS. 1 and 2C, had the binder layer only on the corners of the current collector and the centers of the edges between the corners.

### Example 4

A negative electrode was manufactured in the same manner as in Example 1 except that a binder layer with a thickness of 0.5 μm and a width of 1 mm was formed by continuously coating the binder layer slurry of Example 1 to be 1 mm wide along edges of a stainless steel foil current collector (a thickness: 10 μm) by using a gravure coater and then, drying the current collector at 80° C. The manufactured negative electrode, as shown in FIG. 3, had a structure of having the binder layer continuously formed along the edges of the current collector and the negative electrode coating layer formed on the current collector, wherein a second surface thereof opposite to a first surface of the binder layer in contact with the current collector was covered with the negative electrode coating layer.

### Example 5

A negative electrode was manufactured in the same manner as in Example 1 except that a binder layer with a thickness of 1 μm and a width of 1 mm was formed by continuously coating the binder layer slurry of Example 1 to be 1 mm wide along edges on a stainless steel foil current collector (a thickness: 10 μm) by using a gravure coater and then, drying the coated current collector at 80° C.

The negative electrode, the solid electrolyte of Example 1, and the positive electrode were used in the same manner as in Example 1 to manufacture an all-solid-state full cell.

The negative electrode, the solid electrolyte of Example 1, and the positive electrode were used in the same manner as in Example 1 to manufacture an all-solid-state full cell.

### Example 6

A negative electrode was manufactured in the same manner as in Example 1 except that a binder layer with a thickness of 2 μm and a width of 1 mm was formed by continuously coating the binder layer slurry of Example 1 to be 1 mm wide along edges on a stainless steel foil current collector (a thickness: 10 μm) by using a gravure coater and then, drying the current collector at 80° C.

The negative electrode, the solid electrolyte of Example 1, and the positive electrode were used in the same manner as in Example 1 to manufacture an all-solid-state full cell.

### Comparative Example 1

After mixing carbon black (an average particle diameter: 35 nm) and Ag (an average particle diameter: 60 nm) in a weight ratio of 75:25, the mixture was mixed with an N-methyl pyrrolidone (NMP) solvent, in which a polyvinylidene fluoride binder was dissolved, to prepare negative electrode coating layer slurry. An amount of the polyvinylidene fluoride binder was 11 parts by weight based on 100 parts by weight of the carbon black and Ag mixture, and an amount of the binder was about 10 wt % based on 100 wt % of the entire negative electrode coating layer.

The negative electrode layer slurry was coated on a stainless steel foil current collector (a thickness: 10 μm) and vacuum-dried at 80° C. to manufacture a negative electrode having a 7 μm-thick negative electrode coating layer.

The negative electrode, the solid electrolyte of Example 1, and the positive electrode were used in the same manner as in Example 1 to manufacture an all-solid-state full cell.

### Comparative Example 2

After mixing carbon black (an average particle diameter: 35 nm) and Ag (an average particle diameter: 60 nm) in a weight ratio of 75:25, this mixture was mixed with an N-methyl pyrrolidone (NMP) solvent, in which a polyvinylidene fluoride binder was dissolved, to prepare negative electrode coating layer slurry. Herein, an amount of the polyvinylidene fluoride binder was 7 parts by weight based on 100 parts by weight of the carbon black and Ag mixture, and an amount of the binder was about 6.5 wt % was based on 100 wt % of the entire negative electrode coating layer.

The negative electrode layer slurry was coated on a stainless steel foil current collector (a thickness: 10 μm) and vacuum-dried at 80° C. to manufacture a negative electrode having a 7 μm-thick negative electrode coating layer.

The negative electrode, the solid electrolyte of Example 1, and the positive electrode were used in the same manner as in Example 1 to manufacture an all-solid-state full cell.

### Comparative Example 3

After mixing carbon black (an average particle diameter: 35 nm) and Ag (an average particle diameter: 60 nm) in a weight ratio of 75:25, this mixture was mixed with an N-methyl pyrrolidone (NMP) solvent, in which a polyvinylidene fluoride binder was dissolved, to prepare negative electrode coating layer slurry. An amount of the polyvinylidene fluoride binder was 7 parts by weight based on 100 parts by weight of the carbon black and Ag mixture, and an amount of the binder was about 6.5 wt % was based on 100 wt % of the entire negative electrode coating layer.

The negative electrode layer slurry was coated on a stainless steel foil current collector (a thickness: 10 μm) and dried at 80° C. to manufacture a negative electrode having a 0.5 μm-thick negative electrode coating layer.

On the binder layer, the negative electrode layer slurry was coated and vacuum-dried at 80° C. to form a 7 μm-thick negative electrode coating layer and thereby, manufacture a negative electrode in which the current collector, the binder layer, and the negative electrode coating layer were sequentially formed.

### Experimental Example 1) Image of Peeling Evaluation

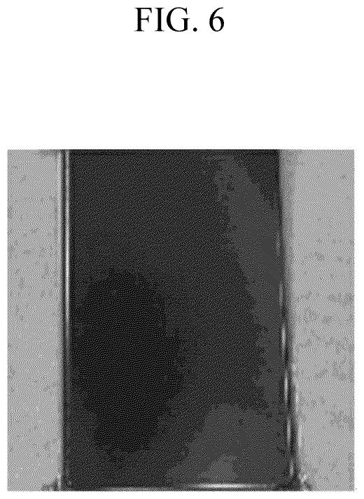

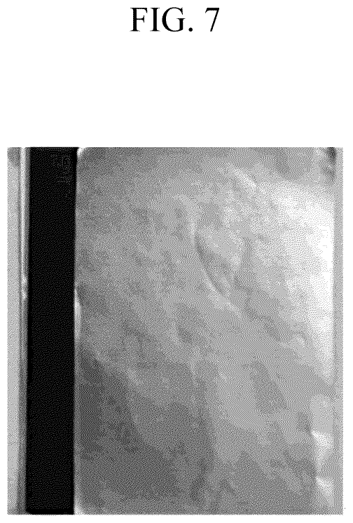

After performing the warm isostatic pressure process in manufacturing the all-solid-state full cells of Example 1 and Comparative Example 2, the negative electrodes were separated. A surface image of each of the negative electrodes was taken at the center, and the results are shown respectively in FIG. 6 (Example 1) and FIG. 7

### Comparative Example 2

As shown in FIG. 6, in Example 1, the negative electrode coating layer did not fall off, and as shown in FIG. 7, in Comparative Example 2, the negative electrode coating layer fell off and exposed the current collector.

### Experimental Example 2) Evaluation of Initial Efficiency

The all-solid-state full cells according to Examples 1 to 6 and Comparative Examples 1 to 3 were charged and discharged at 0.05 C once to obtain a percentage of discharge capacity to charge capacity. The results are shown as initial efficiency in Table 1.

### Experimental Example 3) Evaluation of Output Efficiency

The all-solid-state full cells according to Examples 1 to 6 and Comparative Examples 1 to 3 were charged at 0.1 C and discharged at 1.0 C. A percentage of discharge capacity to charge capacity was calculated, and the results are shown as output efficiency in Table 1.

TABLE 1

| | Whether the | | |
|---|---|---|---|
| | negative electrode | | |
| | coating layer | | |
| | was peeled | Initial | Output |
| | (◯ peeled, | efficiency | efficiency |
| | X not peeled) | (%) | (%) |
| Example 1 | X | 86.7 | 89.7 |
| Example 2 | X | 86.5 | 88.2 |
| Example 3 | X | 86.8 | 89.2 |
| Example 4 | X | 87.0 | 91.3 |
| Example 5 | X | 86.9 | 91.8 |
| Example 6 | X | 86.7 | 90.8 |
| Comparative | X | 84.5 | 84.6 |
| Example 1 | | | |
| Comparative | ◯ | 86.4 | 87.2 |
| Example 2 | | | |
| Comparative | ◯ | 84.0 | 82.1 |
| Example 3 | | | |

As shown in Table 1, the all-solid-state battery cells respectively including the negative electrodes of Examples 1 to 6 exhibited no peeling-off of the negative electrode coating layer and excellent initial efficiency and output efficiency.

Comparative Example 1 (using an excessive amount of a binder in the negative electrode coating layer) exhibited no peeling-off of the negative electrode coating layer but deteriorated initial efficiency and output efficiency. In addition, Comparative Example 2 exhibited excellent initial efficiency but a little deteriorated output efficiency and in addition, peeling-off of the negative electrode coating layer. In addition, Comparative Example 3, even though the binder layer was formed between the current collector and the negative electrode coating layer to completely cover the current collector, exhibited peeling-off of the negative electrode coating layer and deteriorated initial efficiency and output efficiency.

One or more embodiments may provide a negative electrode for an all-solid-state battery with excellent safety.

The negative electrode for an all-solid-state battery according to some embodiments may help reduce a binder amount included in the negative electrode coating layer, while maintaining excellent binding force between the negative electrode coating layer and the current collector.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode for an all-solid-state battery, the negative electrode comprising:
a current collector;
a negative electrode coating layer on the current collector; and
a binder layer continuously or discontinuously along an edge of the current collector.

2. The negative electrode as claimed in claim 1, wherein the binder layer is on the same surface of the current collector as the negative electrode coating layer is on the current collector.

3. The negative electrode as claimed in claim 1, wherein:
the binder layer includes a first surface in contact with the current collector and a second surface opposite to the first surface, and
the negative electrode coating layer covers the second surface of the binder layer.

4. The negative electrode as claimed in claim 1, wherein a height of the binder layer is the same as a height of the negative electrode coating layer.

5. The negative electrode as claimed in claim 4, wherein the binder layer is discontinuously on the edge of the current collector.

6. The negative electrode as claimed in claim 1, wherein a height of the binder layer is smaller than a height of the negative electrode coating layer.

7. The negative electrode as claimed in claim 1, wherein a height of the binder layer is about 5% to about 70% of a height of the negative electrode coating layer.

8. The negative electrode as claimed in claim 1, wherein a ratio of a height of the negative electrode coating layer to a height of the binder layer is about 1:0.05 to about 1:0.7.

9. The negative electrode as claimed in claim 1, wherein a width of the binder layer is greater than or equal to about 0.5 mm and less than or equal to about 10 mm.

10. The negative electrode as claimed in claim 1, wherein the binder layer includes a non-aqueous binder, an aqueous binder, a dry binder, or a combination thereof.

11. The negative electrode as claimed in claim 1, wherein:
the negative electrode coating layer includes a metal, a carbon material, and a negative electrode binder, and
an amount of the negative electrode binder is about 1 wt % to about 9 wt %, based on a total weight of the negative electrode coating layer.

12. The negative electrode as claimed in claim 11, wherein the amount of the negative electrode binder is about 1 wt % to about 6.6 wt %, based on the total weight of the negative electrode coating layer.

13. The negative electrode as claimed in claim 11, wherein the carbon material includes amorphous carbon, crystalline carbon, or a mixture thereof.

14. The negative electrode as claimed in claim 11, wherein the metal includes Ag, Au, Sn, Zn, Al, Mg, Ge, Cu, In, Ni, Bi, Pt, Pd, Si, or a combination thereof.

15. The negative electrode as claimed in claim 11, wherein the negative electrode binder includes a non-aqueous binder.

16. An all-solid-state battery, comprising
the negative electrode as claimed in claim 1;
a positive electrode; and
a solid electrolyte layer between the negative electrode and the positive electrode.

17. The all-solid-state battery as claimed in claim 16, wherein the solid electrolyte layer includes a sulfide solid electrolyte.

18. The all-solid-state battery as claimed in claim 16, further comprising a lithium-containing layer formed during initial charging between the current collector and the negative electrode coating layer.
